(19) United States
(12) Patent Application Publication
(10) Pub. No.: US 2025/0298730 A1
(43) Pub. Date: Sep. 25, 2025

(54) SYSTEM, METHOD, AND COMPUTER PROGRAM FOR MULTI-CHANNEL APPLICATION TESTING USING GENERATIVE ARTIFICIAL INTELLIGENCE

(71) Applicant: Amdocs Development Limited, Limassol (CY)

(72) Inventors: Limor Gueta, Mabuim (IL); Itsik David, Petach Tiqwa (IL); Dror Avrilingi, Modiin (IL)

(21) Appl. No.: 18/610,119

(22) Filed: Mar. 19, 2024

(51) Int. Cl. G06F 11/36

(52) U.S. Cl. CPC G06F 11/3688; G06F 11/368; G06F 11/3692

(57) ABSTRACT

As described herein, a system, method, and computer program are provided for multi-channel application testing using generative AI. A test automation flow generated for an application is accessed. Generative artificial intelligence (AI) is used to automatically adapt the test automation flow to a plurality of versions of the application corresponding to different channels. The plurality of versions of the application are tested using the adapted test automation flows.

### FIELD OF THE INVENTION

The present invention relates to application testing.

### BACKGROUND

Often, a developed application will made available to users through multiple channels. For example, an application may be made available as a web application, a mobile application, etc. As a result, application testing must cover all of these channels to ensure a consistent and seamless experience for customers.

However, currently, even with test automation scripts, it is impossible to cover all possible scenarios for all channels. This is because the test developer will need to adjust an automation script per channel which will take a lot of time and effort.

There is thus a need for addressing these and/or other issues associated with the prior art. For example, there is a need to use generative artificial intelligence (AI) for multi-channel application testing.

### SUMMARY

As described herein, a system, method, and computer program are provided for multi-channel application testing using generative AI. A test automation flow generated for an application is accessed. Generative AI is used to automatically adapt the test automation flow to a plurality of versions of the application corresponding to different channels. The plurality of versions of the application are tested using the adapted test automation flows.

### BRIEF DESCRIPTION OF THE DRAWINGS

FIG. 1 illustrates a method for multi-channel application testing using generative AI, in accordance with one embodiment.

FIG. 2 illustrates a method for training a generative AI model to adapt an input test automation flow to different application channels, in accordance with one embodiment.

FIG. 3 illustrates a method for adapting a test automation flow to different application channels, in accordance with one embodiment.

FIG. 4 illustrates a method for testing different versions of an application corresponding to different channels using adapted test automation flows, in accordance with one embodiment.

FIG. 5 illustrates a network architecture, in accordance with one possible embodiment.

FIG. 6 illustrates an exemplary system, in accordance with one embodiment.

### DETAILED DESCRIPTION

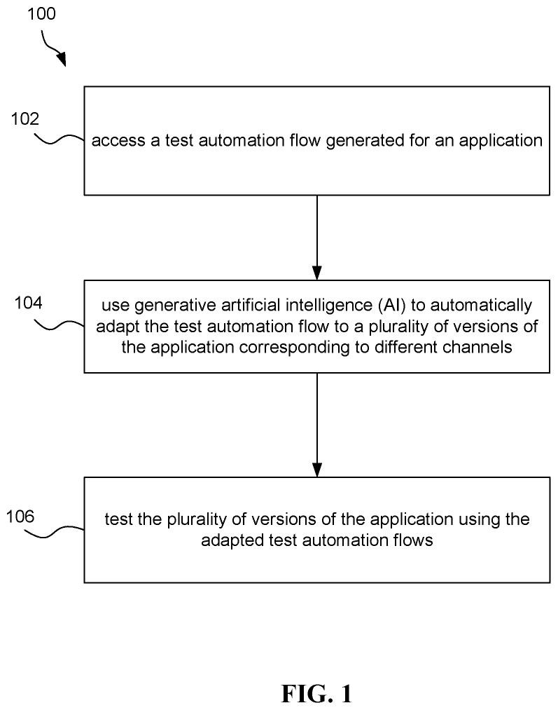

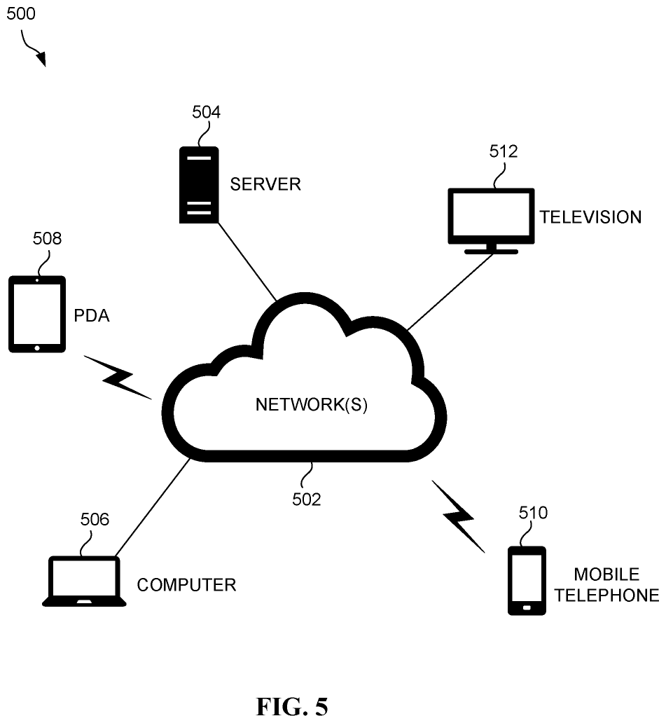

FIG. 1 illustrates a method 100 for multi-channel application testing using generative AI, in accordance with one embodiment. The method may be carried out by a computer system, such as that described below with respect to FIGS. 5 and/or 6.

In operation 102, a test automation flow generated for an application is accessed. The application refers to computer code that is executable to perform some function(s). The application may connect with one or more backend systems (e.g. databases, servers, etc.) to perform the functions. In an embodiment, the application is a front-end application have one or more graphical user interfaces (GUIs) for receiving input from a user and presenting information to the user. As described below, the application may be developed as a plurality of different versions corresponding to different deployment channels. Each version may have one or more different features and/or configurations from other version of the application, which may allow the application to run properly (e.g. without functional and/or visual errors) on the particular channel for which it has been developed.

The test automation flow refers to a test that can be executed on the application automatically. The test automation flow tests the function(s), GUIs, and/or other features of the application, in embodiments. In an embodiment, the test automation flow is an automation script for a user journey within the application. The user journey may include received user input, navigation within input fields and/or GUIs of the application, application output, etc. In an embodiment, the test automation flow may be generated manually. In an embodiment, the test automation flow may be a generic (e.g. template) flow that is not specifically adapted to any of the different versions corresponding to different deployment channels. In another embodiment, the test automation flow may be generated for a specific one of the application versions.

In operation 104, generative AI is used to automatically adapt the test automation flow to a plurality of versions of the application corresponding to different channels. The different channels refer to different platforms on which the application is deployed. For example, the application may be deployed on different platforms for making the application accessible to users via those different platforms.

In an embodiment, the different channels may include a web channel. In this case, the adapted test automation flow may be generated for a web version of the application corresponding to the web channel. In another embodiment, the different channels may include a mobile channel. In this case, the adapted test automation flow may be generated for a mobile version of the application corresponding to the mobile channel. In another embodiment, the different channels may include a desktop channel. In this case, the adapted test automation flow may be generated for a desktop version of the application corresponding to the desktop channel. Other possible channels may include different types of mobile channels (e.g. mobile phone, tablet, etc.), different mobile platforms (e.g. IOS, Android), different web platforms (e.g. Google Chrome, Safari, Internet Explorer, Microsoft Edge, etc.), different desktop platforms (e.g. Microsoft Windows, Linux, Apple Mac, etc.). It should be noted that the plurality of versions of the application may be developed by developers.

As mentioned, generative AI is used to automatically adapt the test automation flow to the plurality of versions of the application corresponding to different the channels. Adapting the test automation flow for a certain version of the application refers to configuring (e.g. updating, changing, etc.) the test automation flow to be executable on that version of the application. As described, each version may be different in one or more ways from other versions of the application, thus necessitating specific configuration of the test automation flow to each version of the application.

In an embodiment, the generative AI adapts the test automation flow based on historical testing data stored for each of the different channels. The historical testing data may include test automation flow adaptions previously generated for other applications. For example, the generative AI may be a pretrained model configured to process an input code (i.e. a test automation flow) and generate an output code (i.e. an adapted test automation flow). In an embodiment, the pretrained model may be fine-tuned using the historical testing data.

In an embodiment, using the generative AI may include separately processing the test automation flow using a generative AI model for each of the different channels. For example, separately processing the test automation flow may include inputting to the generative AI model the test automation flow and an indication of one of the different channels to generate the adapted test automation flow for one of the plurality of versions of the application corresponding to the one of the different channels.

In an embodiment, the adapted test automation flows may be validated. For example, the adapted test automation flows may be manually validated. As another example, the adapted test automation flows may be validated by an automated process. The adapted test automation flows may be validated for error-free execution, for complete test coverage, or for any other defined criteria.

In operation 106, the plurality of versions of the application are tested using the adapted test automation flows. In an embodiment, each of the adapted test automation flow may be executed on its corresponding version of the application. In an embodiment, the adapted test automation flows may be input to an automation environment for use in testing the plurality of versions of the application.

In an embodiment, the plurality of versions of the application may be tested in parallel using the adapted test automation flows. In an embodiment, results of the testing may be collected. In an embodiment, the results of the testing may be displayed in a GUI (e.g. for viewing by a human tester).

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

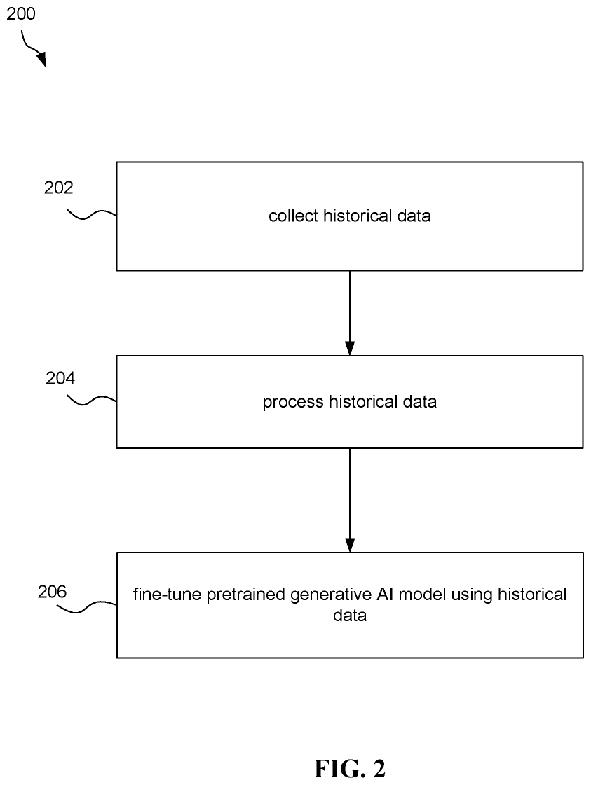

FIG. 2 illustrates a method 200 for training a generative AI model to adapt an input test automation flow to different application channels, in accordance with one embodiment. For example, the method 200 may be carried out to train the generative AI model used in the method 100 of FIG. 1. Of course, however, the flow diagram may be implemented in the context of any desired environment. Further, the aforementioned definitions may equally apply to the description below.

In operation 202, historical data is collected. The historical data may be collected based on unique tokens, requirements and constraints of each channel on which an application can be deployed. The historical data may relate to existing test automation flows and their adaptations for different channels.

This data will serve as the training dataset for the generative AI model. For example, the dataset may include examples of test automation flow adaptions for iOS, Android, and web.

In operation 204, the historical data is processed. Processing refers to configuring the historical data to be in a format capable of being used to train the generative AI model. In an embodiment, the training data prepared by cleaning and preprocessing it. This may include removing duplicates, handling missing values, and formatting the data for training the generative AI model.

In operation 206, a pretrained generative AI model is fine-tuned using the historical data. For example, a custom model that is capable of understanding and generating code or script like content may be used. This custom model may be fine-tuned using the historical data. This step helps the model become more context aware and align its outputs.

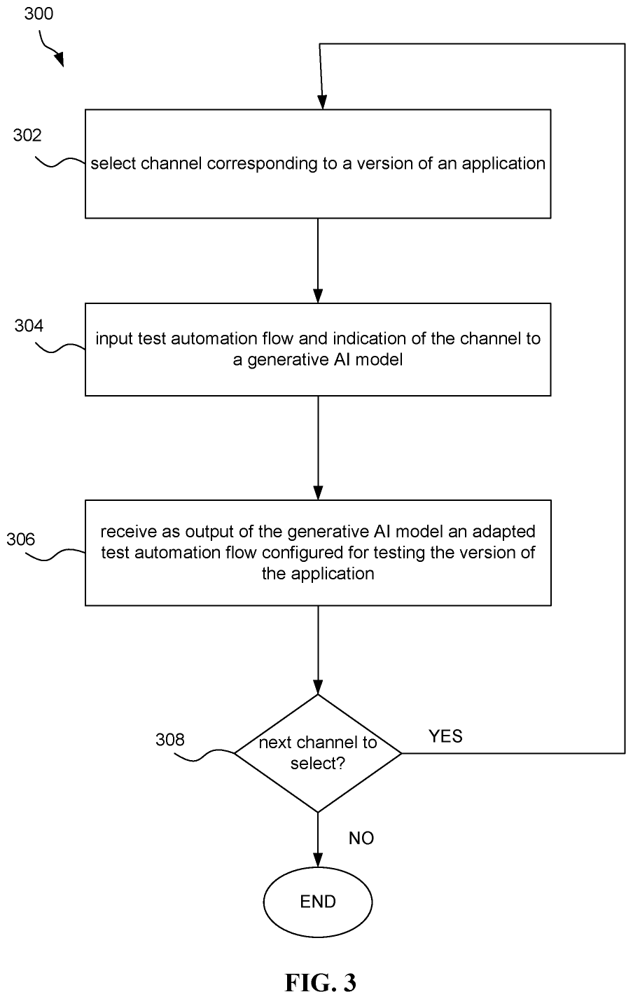

FIG. 3 illustrates a method 300 for adapting a test automation flow to different application channels, in accordance with one embodiment. In an embodiment, the method 300 may be carried out to perform the operation 104 of the method 100 of FIG. 1. Of course, however, the flow diagram may be implemented in the context of any desired environment. Further, the aforementioned definitions may equally apply to the description below.

In operation 302, a channel corresponding to a version of the application is selected. In operation 304, a test automation flow and an indication of the channel is input to a generative AI model. For example, the generative AI model may be already trained per the method 200 of FIG. 2. In an embodiment, a GUI may be presented which allows a user to load the test automation flow and to indicate a specific channel, in order to cause the generative AI model to provide the adjusted test automation flow as output.

In operation 306, an adapted test automation flow configured to test the version of the application is received as output of the generative AI model. By inputting the test automation flow and the indication of a particular channel to the generative AI model in operation 304, the generative AI model may be caused to generate the adapted test automation flow configured for the version of the application. This generated test automation flow may then be received as output from the generative AI model.

In decision 308 it is determined whether there is a next channel to select. This decision may be made based on the different channels for which version of the application have already been developed. When there are more application versions requiring adapted test automation flows to still be generated, the method 300 may decide in decision 308 that there is a next channel to select. In response to this decision, the method 300 returns to operation 302 for this next channel. When it is decided in decision 308 that there is not a next channel to select (e.g. adapted test automation flows have been generated for all application versions), then the method 300 terminates. As an option, the method 300 may include allowing a user to validate one or more of the adapted test automation flows on the application versions corresponding to select channels.

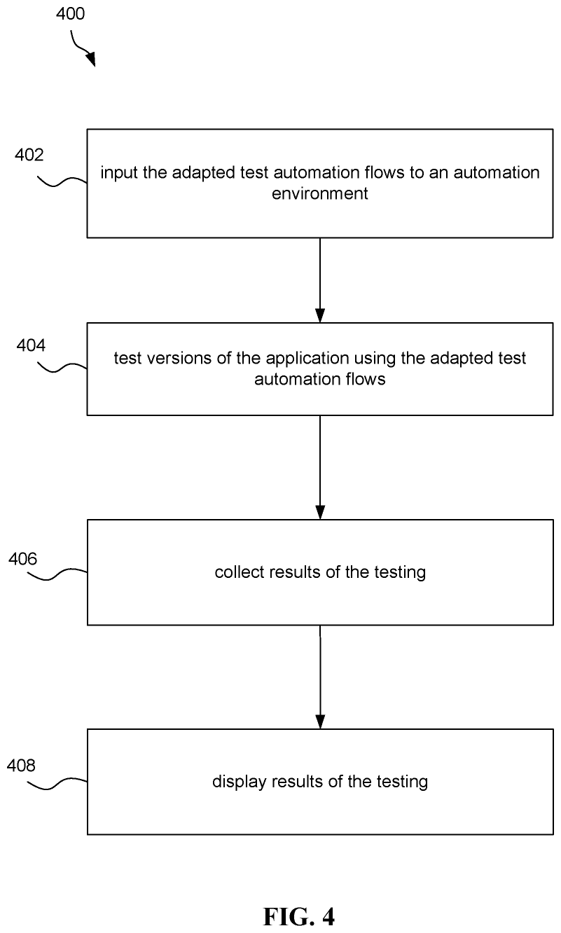

FIG. 4 illustrates a method 400 for testing different versions of an application corresponding to different channels using adapted test automation flows, in accordance with one embodiment. In an embodiment, the method 400 may be carried out to perform the operation 106 of the method 100 of FIG. 1. Of course, however, the flow diagram may be implemented in the context of any desired environment. Further, the aforementioned definitions may equally apply to the description below.

In operation 402, adapted test automation flows are input to an automation environment. In an embodiment, the generative AI model described above may interface a test automation environment such that the adapted test automation flows are output by the generative AI model directly to the test automation environment.

In operation 404, versions of the application are tested using the adapted test automation flows. In an embodiment, AI agents executing in the test automation environment may be triggered to execute the adapted test automation flows on all channels and corresponding application versions or one a select subset of channels and corresponding application versions. Execution of the adapted test automation flows may occur in parallel.

In operation 406, results of the testing are collected. For example, results of the testing of the different versions of the application may be aggregated. In an embodiment, the results that are collected may correspond to certain key performance indicators (KPIs), such as performance, usability, visualization, etc. In an embodiment, a dashboard presenting scores indicative of the test results may be output with recommendations for improvement.

FIG. 5 illustrates a network architecture 500, in accordance with one possible embodiment. As shown, at least one network 502 is provided. In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 504 and an end user computer 506 may be coupled to the network 502 for communication purposes. Such end user computer 506 may include a desktop computer, lap-top computer, and/or any other type of logic. Still yet, various other devices may be coupled to the network 502 including a personal digital assistant (PDA) device 508, a mobile phone device 510, a television 512, etc.

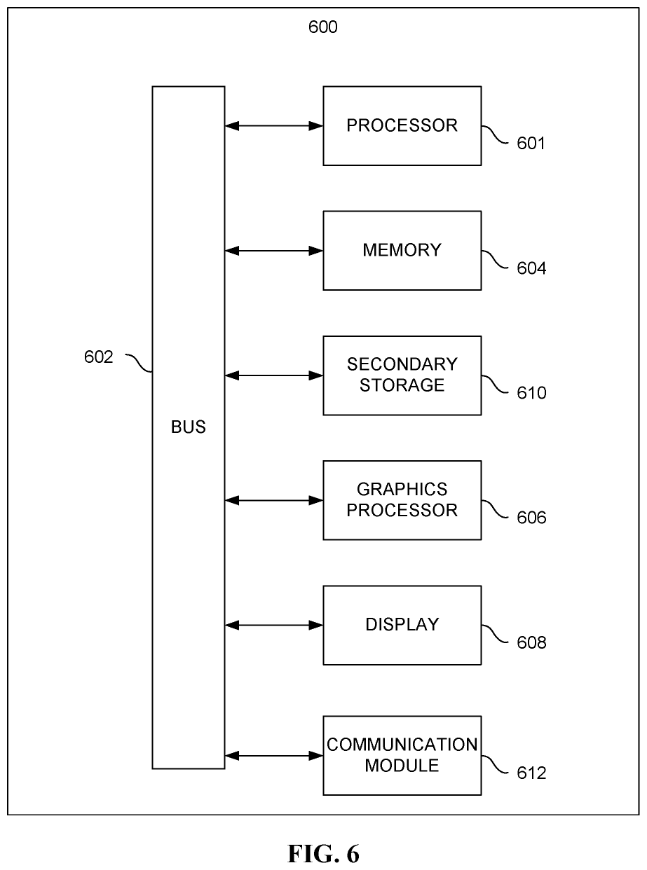

FIG. 6 illustrates an exemplary system 600, in accordance with one embodiment. As an option, the system 600 may be implemented in the context of any of the devices of the network architecture 500 of FIG. 5. Of course, the system 600 may be implemented in any desired environment.

As shown, a system 600 is provided including at least one central processor 601 which is connected to a communication bus 602. The system 600 also includes main memory 604 [e.g. random access memory (RAM), etc.]. The system 600 also includes a graphics processor 606 and a display 608.

The system 600 may also include a secondary storage 610. The secondary storage 610 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 604, the secondary storage 610, and/or any other memory, for that matter. Such computer programs, when executed, enable the system 600 to perform various functions (as set forth above, for example). Memory 604, storage 610 and/or any other storage are possible examples of non-transitory computer-readable media.

The system 600 may also include one or more communication modules 612. The communication module 612 may be operable to facilitate communication between the system 600 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
access a test automation flow generated for an application;
use generative artificial intelligence (AI) to automatically adapt the test automation flow to a plurality of versions of the application corresponding to different channels; and
test the plurality of versions of the application using the adapted test automation flows.

2. The non-transitory computer-readable media of claim 1, wherein the test automation flow is an automation script for a user journey within the application.

3. The non-transitory computer-readable media of claim 1, wherein the different channels include a web channel.

4. The non-transitory computer-readable media of claim 3, wherein the adapted test automation flow is generated for a web version of the application corresponding to the web channel.

5. The non-transitory computer-readable media of claim 1, wherein the different channels include a mobile channel.

6. The non-transitory computer-readable media of claim 5, wherein the adapted test automation flow is generated for a mobile version of the application corresponding to the mobile channel.

7. The non-transitory computer-readable media of claim 1, wherein the generative AI adapts the test automation flow based on historical testing data stored for each of the different channels.

8. The non-transitory computer-readable media of claim 7, wherein the historical testing data includes test automation flow adaptions previously generated for other applications.

9. The non-transitory computer-readable media of claim 7, wherein the generative AI is a pretrained model configured to process an input code and generate an output code.

10. The non-transitory computer-readable media of claim 9, wherein the pretrained model is fine-tuned using the historical testing data.

11. The non-transitory computer-readable media of claim 1, wherein using the generative AI includes separately processing the test automation flow using a generative AI model for each of the different channels.

12. The non-transitory computer-readable media of claim 11, wherein separately processing the test automation flow includes inputting to the generative AI model the test automation flow and an indication of one of the different channels to generate the adapted test automation flow for one of the plurality of versions of the application corresponding to the one of the different channels.

13. The non-transitory computer-readable media of claim 1, wherein the device is further caused to:
validate the adapted test automation flows.

14. The non-transitory computer-readable media of claim 1, wherein the device is further caused to:
input the adapted test automation flows to an automation environment for use in testing the plurality of versions of the application.

15. The non-transitory computer-readable media of claim 1, wherein the plurality of versions of the application are tested in parallel using the adapted test automation flows.

16. The non-transitory computer-readable media of claim 1, wherein the device is further caused to:
collect results of the testing.

17. The non-transitory computer-readable media of claim 16, wherein the results of the testing include at least one score for each of the plurality of versions of the application.

18. The non-transitory computer-readable media of claim 16, wherein the device is further caused to:
display the results of the testing in a graphical user interface (GUI).

19. A method, comprising:
at a computer system:
accessing a test automation flow generated for an application;
using generative artificial intelligence (AI) to automatically adapt the test automation flow to a plurality of versions of the application corresponding to different channels; and
testing the plurality of versions of the application using the adapted test automation flows.

20. A system, comprising:
a non-transitory memory storing instructions; and
one or more processors in communication with the non-transitory memory that execute the instructions to:
access a test automation flow generated for an application;
use generative artificial intelligence (AI) to automatically adapt the test automation flow to a plurality of versions of the application corresponding to different channels; and
test the plurality of versions of the application using the adapted test automation flows.
